(19) United States
(12) Patent Application Publication
(10) Pub. No.: US 2011/0255524 A1
(43) Pub. Date: Oct. 20, 2011

(54) METHOD AND DEVICE FOR WIRELESS ACCESS LOCATION

(75) Inventor: FEI HUANG, Shenzhen City (CN)

(73) Assignees: CHI MEI COMMUNICATION SYSTEMS, INC., Tu-Cheng City (TW); SHENZHEN FUTAIHONG PRECISION INDUSTRY CO., LTD., ShenZhen City (CN)

(21) Appl. No.: 12/837,441

(22) Filed: Jul. 15, 2010

(30) Foreign Application Priority Data
Apr. 20, 2010 (CN) 201010151340.6

(51) Int. Cl. H04W 72/00

(52) U.S. Cl. 370/338

(57) ABSTRACT

A device with automatic wireless network access location includes an access table of WIFI hotspots. The device periodically acquires the longitude and latitude of the device by reading data signals travelling between base stations and the device when the device is not in a WIFI network, and verifies if the device enters a first plurality of areas centered at any entries of the access table within a predetermined radius based on the longitude and latitude acquired from the data signals or a location module of the device. Nearby WIFI hotspots are located accordingly.

### BACKGROUND

1. Technical Field

Embodiments of the present disclosure relate to wireless communications, and more particularly to wireless networking access and a method for location thereof.

2. Description of Related Art

WIFI, the commonly used designator for IEEE 802.11x wireless telecommunication protocol, uses both single-carrier direct-sequence spread spectrum radio technology and multi-carrier orthogonal frequency-division multiplexing (OFDM) radio technology. A WIFI enabled device such as a personal computer, video game console, mobile phone, MP3 player or personal digital assistant can connect to the Internet when within range of a wireless network connected to the Internet. The coverage of one or more (interconnected) access points, or hotspots, can comprise an area as small as a few rooms or as large as many square miles. Coverage in the larger area may depend on a group of access points with overlapping coverage. In addition to private use in homes and offices, WIFI can provide public access at WIFI hotspots provided either free-of-charge or to subscribers to various commercial services.

Communication devices equipped with both WIFI and network connectivity are in common use. Such devices often prefer WIFI network over the network by default. To accomplish this functionality, the device is required to periodically locate active WIFI hotspots, significantly increasing power consumption.

### BRIEF DESCRIPTION OF THE DRAWINGS

FIG. 1 is a block diagram of one embodiment of a device with automatic wireless network access location.

FIG. 2 is a flowchart illustrating one embodiment of a method for automatic wireless network access location.

FIG. 3 is a diagram showing interaction among a device with automatic wireless network access location, base stations and wireless access points.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

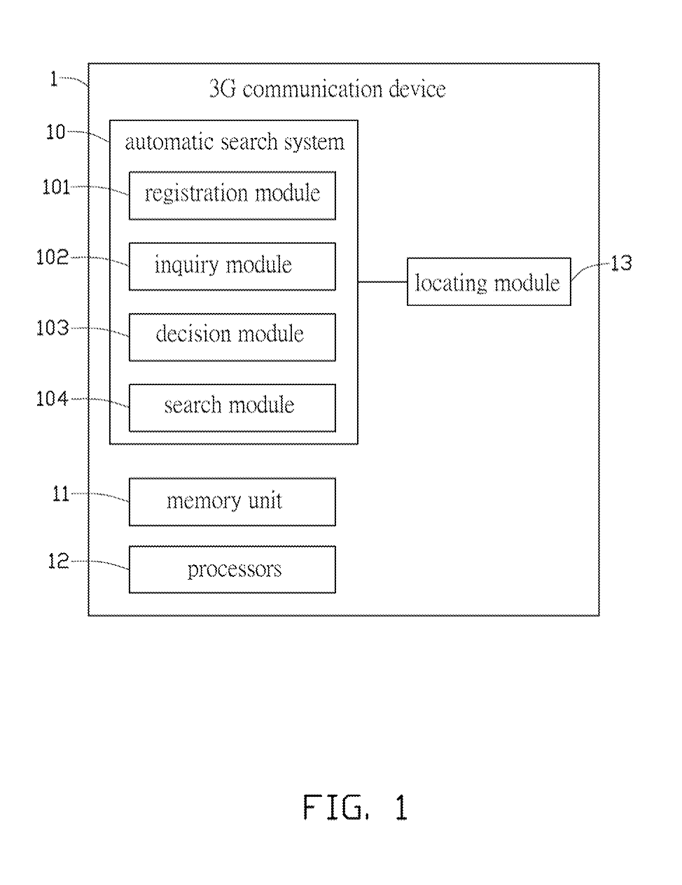

FIG. 1 is a block diagram of one embodiment of a device 1 with an automatic wireless network access location capability. The device 1 can provide a low power consumption solution for the automatic location of WIFI hotspots. The device 1 includes a location module 13 to determine longitude and latitude of the device 1, a memory unit 11 to store an access table 110 storing a plurality of longitudes and latitudes of known WIFI hotspots, one or more processors 12 and an automatic search system 10 comprising one or more computerized codes configured to be executed by the one or more processors 12. The automatic search system 10 includes a registration module 101 to maintain the access table 110, an inquiry module 102, a decision module 103 and a search module 104.

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

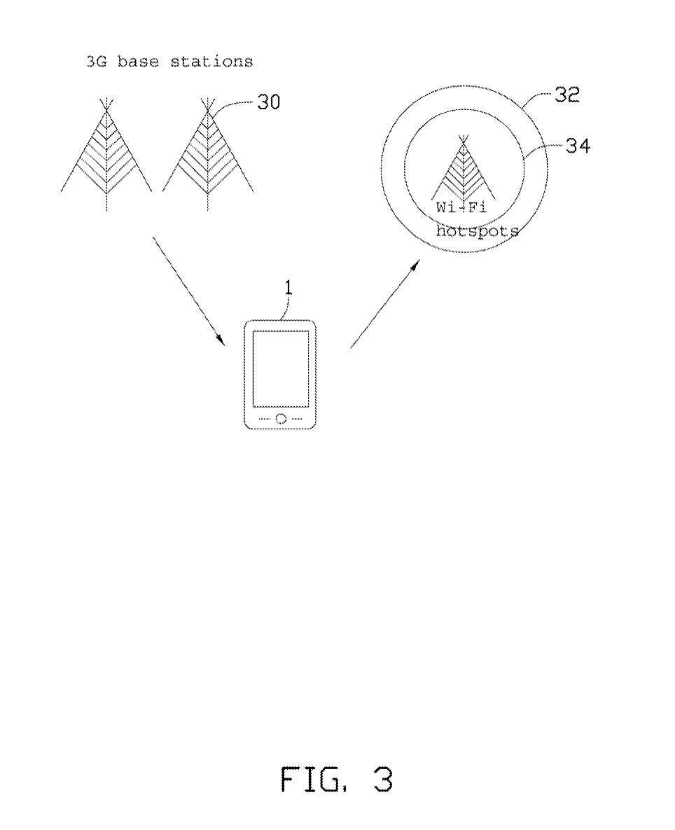

The inquiry module 102 is operable to periodically acquire the longitude and latitude of the device 1 by reading data signals travelling between base stations 30 (in FIG. 3) and the device 1, when the device 1 is not in a WIFI network. The acquired longitude and latitude information are stored in the memory unit 11 and referenced by the decision module 103. The inquiry module 102 also deploys Observed Time Difference of Arrival technology to increase precision of the longitude and latitude information.

The decision module 103 is operable to verify if the device 1 enters a first plurality of areas 32 by referencing the longitude and latitude of the device 1 acquired by the inquiry module 102 and the access table 110. In one embodiment, the first plurality of areas 32 is defined as areas centered at the WIFI hotspots on the access table 110 within a first predetermined radius. Once the device 1 enters a first plurality of areas 32 (in FIG. 3), the location module 13 is triggered to locate the longitude and latitude of the device 1. On the other hand, the location module 13 is suppressed, once the device 1 leaves the first plurality of areas 32 to conserve power. The location module 13 can deploy Assisted Global Positioning System technology in order to provide even higher precision than the Observed Time Difference of Arrival technology. The longitude and latitude located are stored in the memory unit 11 and referenced by the decision module 103.

The decision module 103 is also operable to verify if the device 1 enters a second plurality of areas 34 (in FIG. 3) by referencing the longitude and latitude of the device 1 located by the location module 13 and the access table 110. In one embodiment, the second plurality of areas 34 is defined as areas centered at the WIFI hotspots on the access table 110 within a second predetermined radius which is smaller than the first predetermined radius. Once the device 1 enters the second plurality of areas 34, the search module 104 is triggered to search for nearby WIFI hotspots. The registration module 101 is operable to add a new entry to the access table 110 if the search module 104 finds a WIFI hotspot which is not on the access table 110.

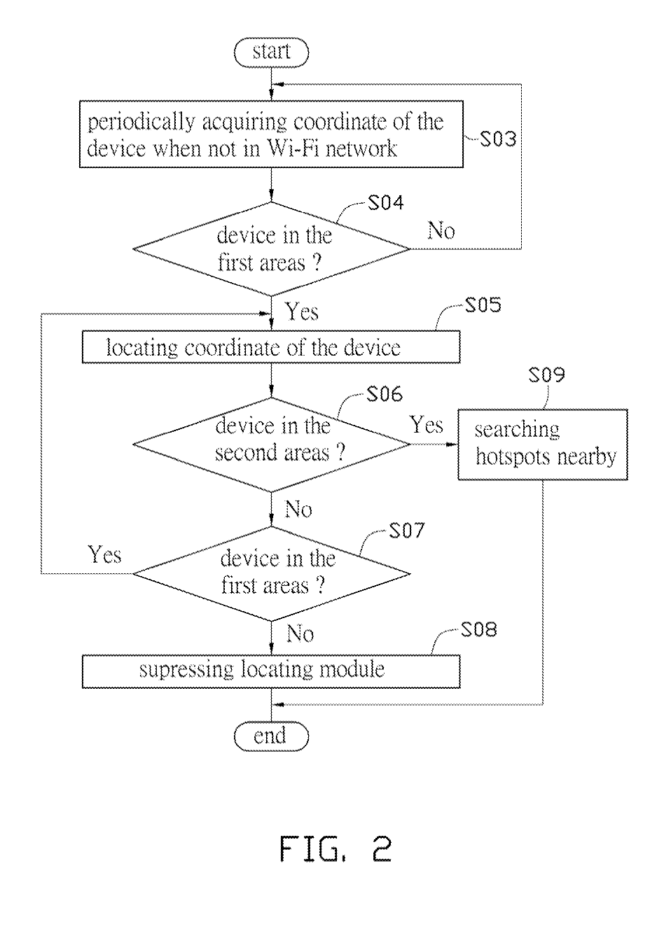

FIG. 2 is a flowchart illustrating one embodiment of a method for automatic wireless network access location. Depending on the embodiments, additional blocks may be added, others removed, and the ordering of the blocks may be changed.

In block S03, the inquiry module102 periodically acquires the longitude and latitude of the device 1 by reading the data signals travelling between the base stations 30 and the device 1, when the device is not in the WIFI network.

In block S04, the decision module 103 verifies if the device 1 enters the first plurality of areas 32. If the device 1 enters the first plurality of areas 32, block S05 is implemented, otherwise the block S03 is repeated. In block S05, the location module 13 determines the longitude and latitude of the device 1.

In block S06, the decision module 103 verifies if the device 1 enters the second plurality of areas 34. If so, block S09 is implemented, otherwise block S07 is implemented. In block S09, the search module 104 is triggered to locate nearby WIFI hotspots.

In block S07, the decision module 103 verifies if the device 1 leaves the first plurality of areas 32. If so, block S08 is implemented, otherwise block S05 is repeated. In block S08, the location module 13 is suppressed to conserve power.

The present disclosure provides an effective alternative to power-consumptive constant searching of WIFI hotspots when out of WIFI network coverage.

It is to be understood, however, that even though numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A device, comprising:
a location module to determine longitude and latitude of the device;
a memory unit to store an access table;
one or more processors; and
one or more programs configured to be executed by the one or more processors, the one or more programs including:
an automatic search system comprising:
an inquiry module to periodically acquire the longitude and latitude of the device by reading data signals travelling between base stations and the device when the device is not in a WIFI network;
a decision module to verify if the device enters a first plurality of areas centered at any entries of the access table within a first predetermined radius based on the longitude and latitude acquired from the data signals and to verify if the device enters a second plurality of areas centered at any entries of the access table within a second predetermined radius based on longitude and latitude located from the location module; and
a search module to locate nearby WIFI hotspots;
wherein the location module is triggered if the device enters the first plurality of areas; and
wherein the search module is triggered if the device enters the second plurality of areas.

2. The device as claimed in claim 1, wherein the access table is a list of longitudes and latitudes of WIFI hotspots.

3. The device as claimed in claim 1, wherein the location module deploys Assisted Global Positioning System technology.

4. The device as claimed in claim 1, wherein the inquiry module deploys Observed Time Difference of Arrival technology.

5. The device as claimed in claim 2, wherein the automatic search system further comprises a registration module to add entries to the access table after the search module finds new hotspots.

6. The device as claimed in claim 3, wherein if the device leaves the first plurality of areas, the location module is suppressed.

7. A method for wireless access location, the method comprising:
acquiring a longitude and latitude of the device by reading data signals travelling between base stations and the device when the device is not in a WIFI network;
verifying if the device is within a first plurality of areas centered at any entries of the access table and circled with a first predetermined radius based on the longitude and latitude acquired from signaling;
verifying if the device is within a second plurality of areas centered at any entries of the access table and circled with a second predetermined radius based on the longitude and latitude located from the location module;
locating nearby WIFI hotspots;
determining the longitude and latitude of the device by the location module; and
suppressing the location module;
wherein determination of the longitude and latitude of the device is executed if the device enters the first plurality of areas; and
wherein location of nearby WIFI hotspots is executed if the device enters the second plurality of areas.

8. The method as claimed in claim 7, wherein the access table contains longitudes and latitudes of WIFI hotspots.

9. The method as claimed in claim 7, wherein the determination of the longitude and latitude of the device utilizes Assisted Global Positioning System technology.

10. The method as claimed in claim 7, wherein acquisition of a longitude and latitude of the device utilizes Observed Time Difference of Arrival technology.

11. The method as claimed in claim 8, wherein the method further comprises a step of registering entries to the access table when location of nearby WIFI hotspots locates new hotspots.

12. The method as claimed in claim 9, wherein suppression of the location module is executed if the device leaves the first plurality of areas.

13. A computer readable storage medium having stored therein an automatic search system, that when executed by a device with network connectivity, a location module, and a memory unit stored an access table, cause the device to:
to acquire a longitude and latitude of the device by reading data signals travelling between base stations and the device when the device is not in a WIFI network;
to verify if the device is within a first plurality of areas centered at any entries of the access table and circled with a first predetermined radius based on the longitude and latitude acquired from signaling;
to verify if the device is within a second plurality of areas centered at any entries of the access table and circled with a second predetermined radius based on the longitude and latitude located from the location module;
to locate nearby WIFI hotspots;
to determine the longitude and latitude of the device by the location module; and
to suppress the location module;
wherein determination of the longitude and latitude of the device is executed if the device enters the first plurality of areas; and
wherein location of nearby WIFI hotspots is executed if the device enters the second plurality of areas.

14. The computer readable storage medium as claimed in claim 13, wherein the access table contains longitudes and latitudes of WIFI hotspots.

15. The computer readable storage medium as claimed in claim 13, wherein determination of the longitude and latitude of the device utilizes Assisted Global Positioning System technology.

16. The computer readable storage medium as claimed in claim 13, wherein acquisition of a longitude and latitude of the device utilizes Observed Time Difference of Arrival technology.

17. The computer readable storage medium as claimed in claim 14, wherein the automatic search system further comprises registration of entries to the access table when location of nearby WIFI hotspots locates new hotspots.

18. The computer readable storage medium as claimed in claim 15, wherein the operation to suppress the location module is executed if the device leaves the first plurality of areas.
